(19) United States
(12) Patent Application Publication
(10) Pub. No.: US 2005/0156808 A1
(43) Pub. Date: Jul. 21, 2005

(54) Structure for communication probe components

(75) Inventor: Wei-Cheng Chung, Taoyuan City (TW)

Correspondence Address: BACON & THOMAS, PLLC, 625 SLATERS LANE, FOURTH FLOOR, ALEXANDRIA, VA, 22314, US

(73) Assignee: P-TWO INDUSTRIES INC., Taoyuan City (TW)

(21) Appl. No.: 10/890,275

(22) Filed: Jul. 14, 2004

(30) Foreign Application Priority Data
Jan. 20, 2004 (TW) 093201228

(51) Int. Cl. H01Q 1/36; H01Q 1/24

(52) U.S. Cl. 343/895; 343/702

(57) ABSTRACT

An improved structure for a communication probe component comprises a cylindrical housing, a post-shaped push up pin, an elastic component and a cap; wherein the cylindrical housing with hollow cavity has two oppositely disposed open ends, so that electrolyte may evenly and completely distribute on the inner wall and bottom surfaces of the hollow cavity during electroplating to ensure excellent electroplating quality; and since the electroplating quality is good for all parts of the communication probe component, the functionality of the communication probe component is ensured without concerns about poor electric conductivity or connection when used as a recharging pin or antenna signal pin for mobile phones

### BACKGROUND OF THE PRESENT INVENTION

1. Field of the Present Invention

The present invention relates generally to an improved structure for communication probe components, and more particularly to an improved structure of recharging pins or antenna signal pins for mobile phones.

2. Description of Prior Act

FIG. 1 shows a prior art communication probe component (10) used as a recharging pin or antenna signal pin for mobile phones. The communication probe component (10) comprises three components in structure, which are generally a cylindrical housing (11), a post-shaped push up pin (12) and an elastic component (13).

The cylindrical housing (11) has a hollow cavity (11a) with an open end and an oppositely disposed closed end. One end of the elastic component (13) is inserted in the hollow cavity (12a) and leans against the bottom end of the hollow cavity (11a) to form a fixed end of the elastic component (13), When inserted in the cylindrical housing (11), the post-shaped push up pin (12) slides up and down in the hollow cavity (11a) like a slider under elasticity of the elastic component (13).

The post-shaped push up pin (12) also has a hollow cavity (12a) with an open end and an oppositely disposed closed end. The end of the elastic component (13) opposite to the fixed end thereof is a free end that is inserted in the hollow cavity (12a) and leans against the top end of the hollow cavity (11a). When both the post-shaped push up pin (12) and elastic component (13) are inserted together in the hollow cavity (1a) of the cylindrical housing (11), the fixed end and free end of the elastic component (13) are positioned in the hollow cavity (11a) of the cylindrical housing (11) and the hollow cavity (12a) of the post-shaped push up pin (12) respectively, so that the post-shaped push up pin (12) is capable to slide up and down under elasticity of the elastic component (13). When pressing the post-shaped push up pin (12), the elastic component (13) is compressed and the post-shaped push up pin (12) slides down inside the cylindrical housing (11). When releasing the post-shaped push up pin (12), the elastic component extends due to restoration of the elasticity thereof and drives the post-shaped push up pin (12) to slide up inside the cylindrical housing (11).

To ensure that the post-shaped push up pin (12) does not separate from the cylindrical housing (11) when sliding up-and-down inside the cylindrical housing (11), a stepwise shoulder (12b) with a larger diameter is disposed on the outer side of the post-shaped push up pin (12), and the outside diameter of the shoulder (12b) is designed slightly smaller than the inside diameter of the cylindrical housing (11). A mechanical reducing process is required after both the post-shaped push up pin (12) and elastic component (13) are inserted together in the hollow cavity (11a) of the cylindrical housing (11) to shrink the open end thereof and form a lip for the hollow cavity (11a). The lip (11b) of the cylindrical housing (11) has a diameter smaller than the outside diameter of the shoulder (12b) of the post-shaped push up pin (12), so that the lower part of the post-shaped push up pin (12) with the shoulder (12b) is wrapped in the hollow cavity (12a) of the cylindrical housing (11) and capable to slide up and down inside the cylindrical housing (11). The elastic component (13) is embedded inside the cylindrical housing (11) and the post-shaped push up pin (12) under slight pressure, so that the post-shaped push up pin (12) is always slightly pushed up by the elastic component (13). When the post-shaped push up pin (12) slides up under the elasticity of the elastic component (13), the shoulder (12b) of the post-shaped push up pin (12) touches the lip (11b) of the cylindrical housing (11), which simultaneously restricts the movement of the post-shaped push up pin (12) inside the cylindrical housing (11) and prevents the post-shaped push up pin (12) from coming off the cylindrical housing (11).

The cylindrical housing (11), post-shaped push up pin (12) and elastic component (13) as described above forms the prior art communication probe component (10).

However, when such prior art communication probe component (10) is used as a recharging pin or antenna signal pin for mobile phones, poor electric conductivity or connection occurs very often and causes battery recharging failure or bad transmission or receiving quality.

It is the poor electroplating of the prior communication probe component (10) that contributes to the recharging failure and bad quality. Uneven or incomplete electroplating is found often on the surface of the area for electric connection of the communication probe component (10), especially on the inner wall and bottom surfaces of the hollow cavity (11a) of the cylindrical housing (11), so that failures occur in electric connection between the elastic component (13) and the cylindrical housing (11), though the post-shaped push up pin (12) and the elastic component (13) are electrically well connected.

The structure of the cylindrical housing (11) is the major cause for the uneven or incomplete electroplating on the inner wall and bottom surfaces of the hollow cavity (11a) of the cylindrical housing (11). When the cylindrical housing (11) is immerged in electrolyte for electroplating, the air in the hollow cavity (11a) cannot escape due to the structure thereof with one open end and one closed end. Even though the electrolyte permeates through the hollow cavity (11a), residual air may remain therein without being squeezed out by the electrolyte and hinders even and complete distribution of the electrolyte through the inner wall and bottom surfaces of the hollow cavity (11a). Consequently, the electroplating on the inner wall and bottom surfaces of the hollow cavity (11) of the cylindrical housing (12) is found poor very often.

### SUMMARY OF THE PRESENT INVENTION

The primary objective of the present invention is to provide an improved structure for a communication probe component to remove poor electroplating quality and ensure the functionality thereof without any battery recharging failure or bad transmission or receiving quality when used as a recharging pin or a antenna signal pin for mobile phones.

The second objective of the present invention is to provide an improved four-component structure for a communication probe component comprising a cylindrical housing, a post-shaped push up pin, an elastic component and a cap. The hollow cavity of the cylindrical housing has two oppositely disposed open ends, so that electrolyte can thoroughly squeeze air out of the hollow cavity of the cylindrical housing and distribute on the inner wall and bottom surfaces of the hollow cavity evenly and completely. In doing so, no poor electroplating exists and the functionality of the communication probe component used as a recharging pin or antenna signal pin is assured.

The third objective of the present invention is to provide an improved structure for a communication probe component the cylindrical housing of which has a hollow cavity with two oppositely disposed open end. With such structure, a stepwise neck with smaller diameter is formed directly on the inner wall of the hollow cavity to restrict the shoulder of the post-shaped push up pin with larger diameter. No mechanical reducing process is required to prevent the post-shaped push up pin from coming off the cylindrical housing. The post-shaped push up pin and cylindrical housing, together with the elastic component and cap, form the communication probe component of the present invention.

### BRIEF DESCRIPTION OF THE DRAWING FIGURES

FIG. 1 shows a cross section view of a structure of the prior art communication probe component (10);

FIG. 2 shows an external schematic view of the communication probe component (20) of the present invention;

FIG. 3 shows a cross section view of the structure of the communication probe component (20);

FIG. 4 shows an exploded view of the assembly of the communication probe component (20); and

FIG. 5 shows an application of the communication probe component (20) as a recharging pin of a mobile phone for battery (25) recharging.

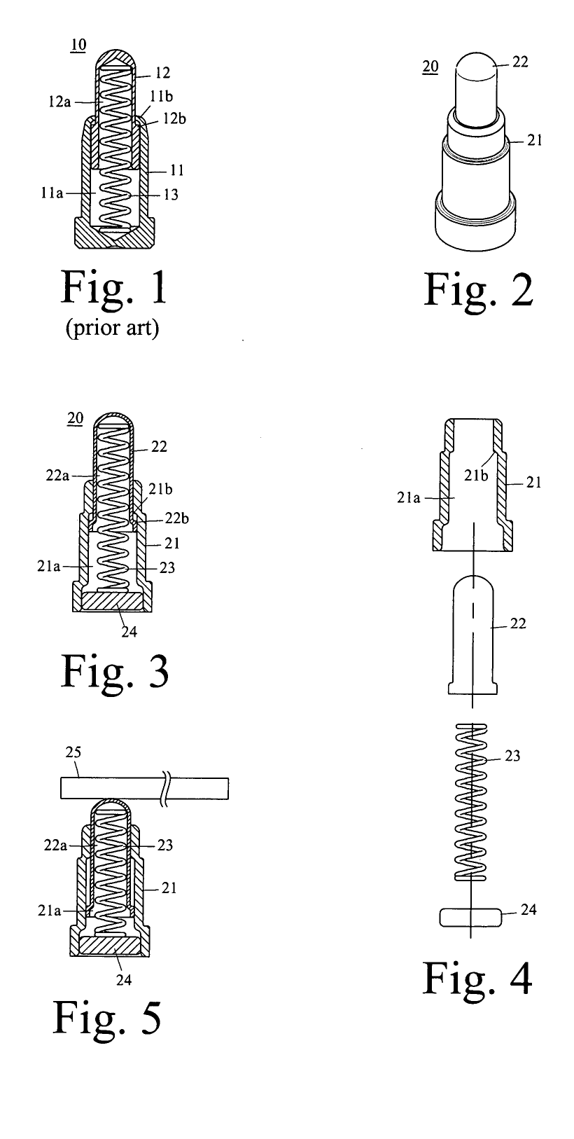

### DETAILED DESCRITION OF THE PREFERRED EMBODIMENTS

As shown in FIGS. 2-4, the communication probe component (20) of the present invention comprises four components: a cylindrical housing (21), a post-shaped push up pin (22), an elastic component (23), and a cap (24).

The cylindrical housing (21) has a hollow cavity (21a) with two oppositely disposed open ends, so that a stepwise profile is directly formed on the inner wall of the hollow cavity (21a) when making the cylindrical housing (21). Such stepwise profile comprises one part with a larger diameter and another part with a smaller diameter, and the connection area of both parts forms a neck (21b) on the inner wall of the hollow cavity (21a).

The post-shaped push up pin (22) is similar to the prior art post-shaped push up pin (12) in structure and has a hollow cavity (22a) with an open end and an oppositely disposed closed end. The elastic component (23) has a free end that is inserted in the hollow cavity (22a) and leans against the top end of the hollow cavity (22a) to form a good electric connection area. A stepwise shoulder (22b) with a larger diameter is formed on the outside diameter of the post-shaped push up pin (22). The diameter of the shoulder (22b) of the post-shaped push up pin (22) is appropriate for the post-shaped push up pin (22) to slide up and down inside the hollow cavity (21a) of the cylindrical housing (21).

A preferable embodiment of the present invention is to provide a solid post-shaped push up pin (22) without the hollow cavity (22a). One free end of the elastic component (23) leans against the underside of the post-shaped push up pin (22) to drive the post-shaped push up pin (22) to slide up and down inside the hollow cavity (21a) of the cylindrical housing (21) and form a good electric connection area with the post-shaped push up pin (22).

The diameter of the cap (24) is appropriate to plug tightly with the open end on the bottom of the hollow cavity (21a) of the cylindrical housing (21) to form a closed end of the cylindrical housing (21).

As shown in FIGS. 3 and 4, when the post-shaped push up pin (22) is inserted in the hollow cavity (21a) of the cylindrical housing (21) from the bottom thereof, the shoulder of the post-shaped push up pin (22) touches the neck (21b) of the cylindrical housing (21) eventually. Due to the restriction of the neck (21b) of the cylindrical housing (21), only the front part of the post-shaped push up pin (22) protrudes out of the cylindrical housing (21) without the possibility for the entire post-shaped push up pin (22) to come off the cylindrical housing (21).

One end of the elastic component (23) is inserted in the hollow cavity (21a) of the cylindrical housing (21) and further in the hollow cavity (22a) of the post-shaped push up pin and leans against the top end thereof. The bottom end of the cylindrical housing (21) is closed by plugging the cap (24) tightly with the open end on the bottom of the cylindrical housing (21), so that another end of the elastic component (23) leans against the cap (24) and forms the fixed end of the elastic component (23). The cylindrical housing (21), post-shaped push up pin (22), elastic component (23), and cap (24) as described above form the communication probe component (20) of the present invention.

When pressing the post-shaped push up pin (22), the elastic component (23) is compressed and the post-shaped push up pin (22) slides down inside the cylindrical housing (21). When releasing the post-shaped push up pin (22), the elastic component extends due to restoration of the elasticity thereof and drives the post-shaped push up pin (22) to slide up inside the cylindrical housing (21), till the shoulder (22b) of the post-shaped push up pin (22) touches the neck (21b) of the cylindrical housing (21).

The function of the communication probe component (20) of the present invention has the same functionality as the prior art communication probe component (10) and is used as a recharging pin or antenna signal pin for mobile phones. However, thanks to good electroplating quality, for which the prior art communication probe component (10) lacks, poor electric conductivity or connection is out of the question for the communication probe component (20) of the present invention, which successfully solve the problems of battery recharging failure and bad transmission or receiving quality.

The improved structure of the hollow cavity (21a) of the cylindrical housing (21) with two open ends is the key for the present invention to ensure high electroplating quality. With such structure, the electrolyte permeates in the hollow cavity (21a) very easily and squeezes out the air therein thoroughly, facilitating an even distribution of the electrolyte through the inner wall surface of the hollow cavity (21a) and ensuring a high electroplating quality thereon. The bottom of the cylindrical housing (21) is formed with the tightly plugged cap (24) and uneven electroplating is out of the question for the cap (24) due to the solid structure thereof. Therefore, after the cap (24) is plugged tightly to form the bottom of the cylindrical housing (21), high electroplating quality is ensured for the inner wall and bottom surfaces of the hollow cavity (21a) of the cylindrical housing (21).

It is confirmed based on the aforementioned description that no failure or problem in electric connection between the post-shaped push up pin (22) and elastic component (23) and between the elastic component (23) and cylindrical housing (21) or cap (24). Thus, the communication probe component (20) functions well without the problem of poor electric conductivity or connection that causes battery recharging failure or bad transmission or receiving quality when the communication probe component (20) is used for mobile phones.

As shown in FIG. 5, the communication probe component (20) may be used as a recharging pin for mobile phones. When insert the battery (25) at the right position, the post-shaped push up pin (22) of the communication probe component (20) is pressed downward and slides down inside the cylindrical housing (21). In the meantime, the compressed elastic component (23) has a potential to extend under the pressure and, thus, brings a potential for the post-shaped push up pin (22) to slide up. This upward push force ensure a seamless contact of the top end of the post-shaped push up pin (22) with the conductive area of the battery (25) for perfect electric connection. Further, outstanding electroplating quality of the communication probe component (20) ensured good electric connection between components, especially between the battery (25) and the communication probe component (20), without concerns for poor electric conductivity or contact.

1. An improved structure for communication probe components, comprising a cylindrical housing, a post-shaped push up pin, an elastic component, and a cap; wherein
said cylindrical housing has a hollow cavity with two oppositely disposed open ends; which inner wall of the hollow cavity of said cylindrical housing is formed as stepwise profile having a connection area connected with a lager diameter and a smaller diameter formed as a neck;
said post-shaped push up pin has a stepwise shoulder with a larger diameter to outside diameter of said post-shaped push up pin; which shoulder of said post-shaped push up pin is touched to the neck formed on inner wall of said cylindrical housing when said post-shaped push up pin inserted into the hollow cavity of said cylindrical housing;
said elastic component with a free end contacts with said post-shaped push up pin and has a potential to push said post-shaped push up pin upwards; and
said cap plugs tightly in an open end at the bottom of said hollow cavity and forms as a solid bottom of said cylindrical housing to having said elastic component with a fixed end contacted with said cap.

2. The improved structure for communication probe components as recited in claim 1, wherein said post-shaped push up pin has a hollow cavity with one open end and one oppositely disposed closed end.
